(19) United States
(12) Patent Application Publication
(10) Pub. No.: US 2006/0164367 A1
(43) Pub. Date: Jul. 27, 2006

(54) Dual display device

(75) Inventors: Bo-Young An, Gyeonggi-do (KR); Dong-Won Lee, Gyeonggi-do (KR); Dong-Hwan Kim, Gyeonggi-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/223,380

(22) Filed: Sep. 8, 2005

(30) Foreign Application Priority Data
Jan. 21, 2005 (KR) 10-2005-0005799

(51) Int. Cl. G09G 3/36

(52) U.S. Cl. 345/98

(57) ABSTRACT

A display device includes a first panel unit, a first driving chip driving the first panel unit, a second panel unit, and a second driving chip driving the second panel unit, wherein the first and second driving chips share at least a portion of a plurality of power supply voltages required for driving the first panel unit and the second panel unit.

### BACKGROUND OF THE INVENTION

(a) Field of the Invention

The present invention relates to a dual display device, and in particular, to a small and medium sized dual display device that is capable of sharing a power supply voltage.

(b) Description of Related Art

Recently, flat panel displays such as organic light emitting diode (“OLED”) displays, plasma display panels (“PDPs”) and liquid crystal displays (“LCDs”) instead of heavy and large cathode ray tubes (“CRTs”) have been widely developed.

The PDPs are devices which display characters or images using plasma generated by a gas-discharge. The OLED displays are devices which display characters or images by applying an electric field to specific light-emitting organics or high molecule materials. The LCDs are devices which display images by applying an electric field to a liquid crystal layer disposed between two panels and regulating the strength of the electric field to adjust a transmittance of light passing through the liquid crystal layer.

Among the flat panel displays, as examples, the LCD and the OLED display each include a panel unit provided with pixels including switching elements and display signal lines, a gate driver providing a gate signal for gate lines of the display signal lines to turn on/off the switching elements, a data driver providing a data signal for data lines of the display signal lines to apply a data voltage to the pixel via the turned-on switching elements, a signal controller controlling the above-described elements, and a driving voltage generator providing constant voltages thereto.

Among these display devices, such as a small and medium sized display device, a so-called dual display device which has panel units in the inner and outer sides thereof is being developed.

The dual display device includes a main panel unit mounted on the inner side, a subsidiary panel unit mounted on the outer side, a driving flexible printed circuit film (FPC) provided with signal lines to transmit input signals from external devices, an auxiliary FPC connecting the main panel unit to the subsidiary panel unit, and a main driving chip mounted on the panel unit and a subsidiary driving chip mounted on the subsidiary panel unit which control the above-described elements.

The driving chips generate control signals and driving signals for controlling the main panel unit and the subsidiary panel unit, and voltages, and are generally mounted as a COG (chip on glass) structure. The driving FPC is also called an interface FPC in that it connects the external device with the main panel unit.

Meanwhile, using two chips for the main driving chip and the subsidiary driving chip is disadvantageous in a cost point of view and increases the number of elements for driving each driving chip to enlarge the size of the display device.

### SUMMARY OF THE INVENTION

An object of the present invention is to provide a dual display device that is capable of solving such conventional problems.

A display device is provided, which includes a first panel unit, a first driving chip driving the first panel unit, a second panel unit, and a second driving chip driving the second panel unit, wherein the first and second driving chips share at least a portion of a plurality of power supply voltages required for driving the first panel unit and the second panel unit. The power supply voltages may include first to third voltages, and the first to third voltages are generated from the first driving chip and are supplied to the second driving chip.

The power supply voltages may further include fourth and fifth voltages, wherein the fourth and fifth voltages are generated from the first driving chip and are supplied to the second driving chip.

The power supply voltages may further include fourth to seventh voltages, wherein the fourth to seventh voltages are generated from the first driving chip, and the sixth and seventh voltages are supplied to the second driving chip. Alternatively, the fourth and fifth voltages are generated from the first driving chip, and the sixth and seventh voltages are generated from the second driving chip.

The power supply voltages may further include fourth to sixth voltages, wherein the fourth to sixth voltages are generated from the first driving chip, and the fourth and sixth voltages are supplied to the second driving chip. Alternatively, the fourth and fifth voltages are generated from the first driving chip, the sixth voltage is generated from the second driving chip, and the fourth voltage is supplied to the second driving chip.

The display device may further include first and second flexible printed circuit films (FPCs) each attached to one side of the respective first and second panel units, and a third FPC having a first side and a second side, where the first and second FPCs are attached to the respective first and second sides of the third FPC. The third FPC may be provided with a power supply line transmitting the plurality of power supply voltages.

The first and second panel units may be provided with a plurality of pixels each including a switching element, and first and second display signal lines connected to the switching elements.

The display device may further include a gate driver generating gate signals for application to the first display signal lines, and a data driver generating data voltages for application to the second display signal lines.

The first and second driving chips each may include the gate driver and the data driver for the respective first and second panel units.

The display device may further include a gray voltage generator generating gray voltages for application to the data driver, and a common voltage generator generating a common voltage, and they may each further include the gray voltage generator and the common voltage generator. The first and second driving chips may be mounted on the first and second panel units, respectively.

In other embodiments, the plurality of power supply voltages may include first to fifth voltages, wherein the first and second driving chips share at least the first to third voltages in common.

The display device may further include a gate driver receiving the first and second voltages to generate gate signals, a data driver receiving the third voltage to generate data voltages, a gray voltage generator receiving the fourth voltage to generate gray voltages, and a common voltage generator receiving the fifth voltage to generate a common voltage.

The display device may further include first and second FPCs each attached to one side of the respective first and second panel units, and a third FPC having a first side and a second side, where the first and second FPCs are attached to the respective first and second sides of the third FPC. The third FPC may be provided with a power supply line transmitting the plurality of power supply voltages.

The first and second driving chip may be mounted as a COG (chip on glass) structure on the first and second panel units, respectively, and they may each include at least one of the gate driver, the data driver, the gray voltage generator, and the common voltage generator.

### BRIEF DESCRIPTION OF THE DRAWINGS

The present invention will become more apparent by describing preferred embodiments thereof in detail with reference to the accompanying drawings, in which:

FIG. 1 is a block diagram of a display device according to an exemplary embodiment of the present invention;

FIG. 2 illustrates a structure and an equivalent circuit diagram of a pixel of a liquid crystal display (LCD) according to an exemplary embodiment of the present invention;

FIGS. 3A and 3B are schematic views of a display device according to an exemplary embodiment of the present invention;

FIG. 4 is a schematic lateral side view of a display device according to an exemplary embodiment of the present invention;

FIG. 5 is a block diagram of the main driving chip and the subsidiary driving chip shown in FIG. 3A; and

FIGS. 6-10 show a plurality of exemplary schemes of sharing voltages in a dual display device according to an embodiment of the present invention.

### DETAILED DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

A display device according to embodiments of the present invention will now be described with reference to the drawings.

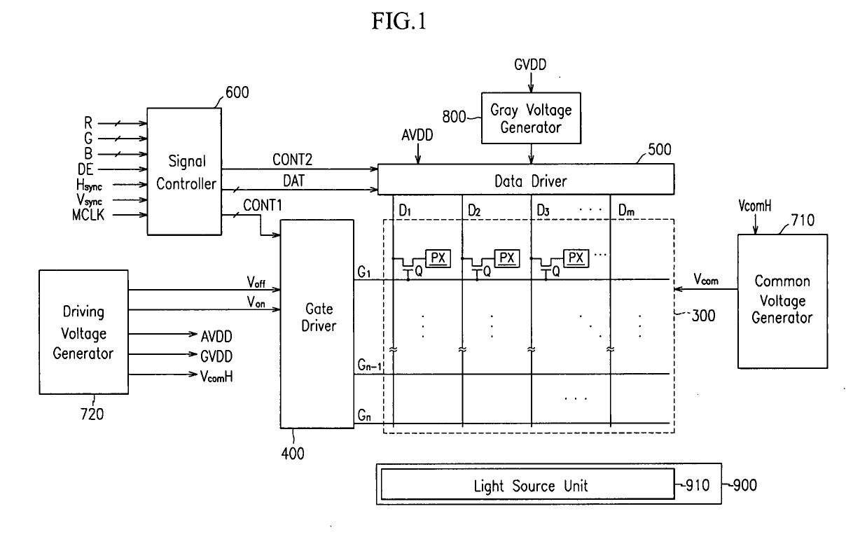

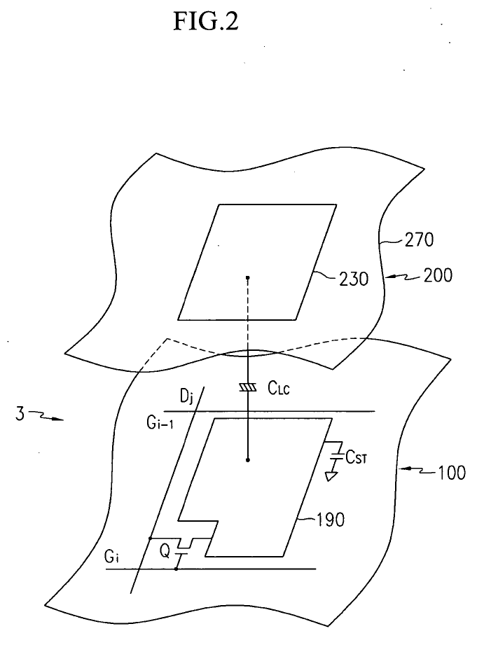

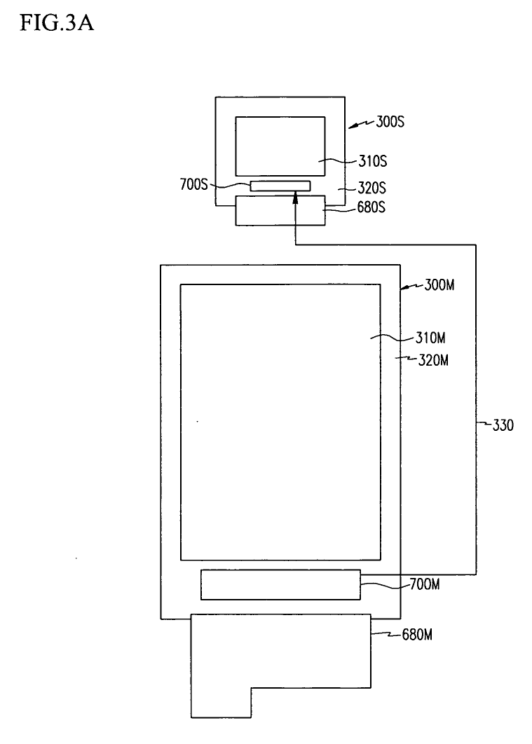

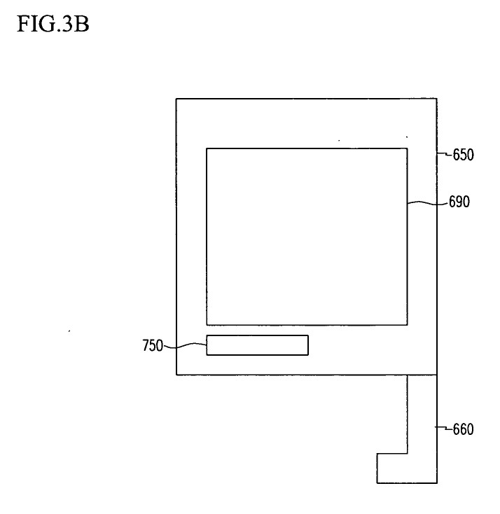

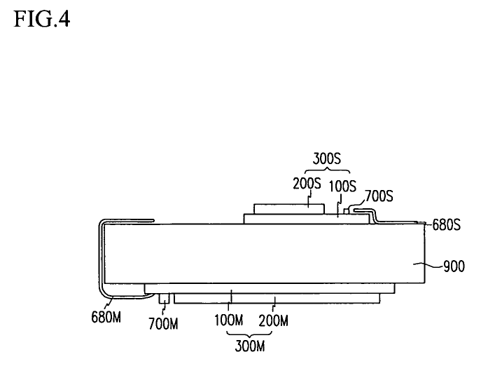

FIG. 1 is a block diagram of a display device according to an embodiment of the present invention, FIG. 2 illustrates a structure and an equivalent circuit diagram of a pixel of an LCD according to an exemplary embodiment of the present invention, FIGS. 3A and 3B are schematic views of a display device according to an exemplary embodiment of the present invention, and FIG. 4 is a schematic lateral side view of a dual display device according to an exemplary embodiment of the present invention.

Referring to FIG. 1, a display device according to an exemplary embodiment of the present invention includes a panel unit 300 and a common voltage generator 710 connected thereto, a gate driver 400 and a data driver 500 connected thereto, a gray voltage generator 800 connected to the data driver 500, a signal controller 600 controlling the above-described elements, a backlight unit 900 providing light for the panel unit 300, and a driving voltage generator 720 generating driving voltages.

The panel unit 300 includes a plurality of display signal lines G₁-Gₙ and D₁-Dₘ and a plurality of pixels connected to the display signal lines G₁-Gₙ and D₁-Dₘ and arranged substantially in a matrix structure. The panel unit 300 includes a lower panel 100 and an upper panel 200.

The display signal lines G₁-Gₙ and D₁-Dₘ are provided on the lower panel 100 and include gate lines G₁-Gₙ transmitting gate signals (called scanning signals) and data lines D₁-Dₘ transmitting data signals. The gate lines G₁-Gₙ extend substantially in a row direction and are substantially parallel to each other, while the data lines D₁-Dₘ extend substantially in a column direction and are substantially parallel to each other.

Each pixel includes a switching element Q connected to one of the gate lines G₁-Gₙ and one of the data lines D₁-Dₘ, and pixel circuits PX connected to the switching element Q. The switching element Q is provided on the lower panel 100 and has three terminals: a control terminal connected to one of the gate lines G₁-Gₙ; an input terminal connected to one of the data lines D₁-Dₘ; and an output terminal connected to the pixel circuit PX.

In active matrix type LCDs, which are an example of a flat panel display device, the panel unit 300 includes the lower panel 100, the upper panel 200, a liquid crystal (LC) layer 3 disposed between the lower and upper panels 100 and 200, and the display signal lines G₁-Gₙ and D₁-Dₘ and the switching elements Q are provided on the lower panel 100. Each pixel circuit PX includes an LC capacitor C_{LC} and a storage capacitor C_{ST} that are connected in parallel with the switching element Q. The storage capacitor C_{ST} may be omitted if it is not needed.

The LC capacitor C_{LC} includes a pixel electrode 190 on the lower panel 100, a common electrode 270 on the upper panel 200, and the LC layer 3 as a dielectric between the pixel and common electrodes 190 and 270. The pixel electrode 190 is connected to the switching element Q, and the common electrode 270 covers the entire surface of the upper panel 200 and is supplied with a common voltage Vcom. Alternatively, both the pixel electrode 190 and the common electrode 270, which have shapes of bars or stripes, are provided on the lower panel 100.

The storage capacitor C_{ST} is an auxiliary capacitor for the LC capacitor C_{LC}. The storage capacitor CST includes the pixel electrode 190 and a separate signal line (not shown), which is provided on the lower panel 100 and overlaps the pixel electrode 190 with an insulator disposed between the pixel electrode 190 and the separate signal line. The storage capacitor C_{ST} is supplied with a predetermined voltage such as the common voltage Vcom. Alternatively, the storage capacitor C_{ST} includes the pixel electrode 190 and an adjacent gate line called a previous gate line, which overlaps the pixel electrode 190 with an insulator disposed between the pixel electrode 190 and the previous gate line.

For color display, each pixel uniquely represents one of three primary colors such as red, green, and blue colors (spatial division) or sequentially represents the three primary colors in time (temporal division), thereby obtaining a desired color. FIG. 2 shows an example of the spatial division in which each pixel includes a color filter 230 representing one of the three primary colors in an area of the upper panel 200 facing the pixel electrode 190. Alternatively, the color filter 230 is provided on or under the pixel electrode 190 on the lower panel 100.

A pair of polarizers (not shown) for polarizing light are attached on outer surfaces of the lower and upper panels 100 and 200 of the panel unit 300.

The backlight unit 900 of the LCD includes a light source unit 910 including a plurality of lamps (not shown) provided at the lower side of the LC panel unit 300. For a small and medium sized LCD, light emitting diodes (LEDs) are used as the lamp, and the LCD may be lit from the edge in which the lamps are disposed at the edge of the lower side with a light guide plate.

Meanwhile, referring to FIGS. 3A-4, a dual display device according to an embodiment of the present invention includes two panel units of a main panel unit 300M and a subsidiary panel unit 300S, and a main FPC 680M attached to the main panel unit 300M, a driving FPC 650 attached to the main FPC 680M, an auxiliary FPC 680S attached between the main and the subsidiary units 300M and 300S, and driving chips 700M and 700S mounted on the main and the subsidiary panel units 300M and 300S, respectively.

The panel units 300M and 300S include display areas 310M and 310S forming screens, and peripheral areas 320M and 320S, respectively. The peripheral areas 320M and 320S may include light-blocking layers (not shown) (“black matrix”) for blocking light. Most of the pixels and the display signal lines G₁-Gₙ and D₁-Dₘ are disposed in the display areas 310M and 320M.

The main panel unit 300M and the subsidiary panel unit 300S are connected via a power supply line 330 provided on the driving FPC 650. The main FPC 680M is attached to the lower side of the main panel unit 300M, the auxiliary FPC 680S is attached to the lower side of the subsidiary panel unit 300S, and the main and auxiliary FPC 680M and 680S are attached to different sides of the driving FPC 650, respectively.

The driving FPC 650, which is also called an interface FPC, includes a connector 660 connected to an external device and is provided with signal lines (not shown) transmitting signals from the external device and pads (not shown) at the ends thereof. Additionally, the main and auxiliary FPC 680M and 680S and the panel units 300M and 300S are also provided with pads.

The driving FPC 650 has an opening 690 exposing the subsidiary panel unit 300S in a folded state, and has a driving circuitry unit 750 controlling currents applied to the light source unit 910 of the backlight unit 910.

To electrically connect the pads of the driving FPC 650, the pads of the main and subsidiary FPCs 680M and 680S and the pads of the panel units 300M and 300S, soldering or an anisotropic conductive film may be used.

The backlight unit 900 provides light for two panel units 300M and 300S through the light source unit 910 disposed at the left with respect to FIG. 4 and a light guide plate (not shown), and two panel units 300M and 300S are disposed opposite to each other interposing the backlight unit 900.

The two panel units 300M and 300S include lower panels 100M and 100S and upper panels 200M and 200S, and the driving chips 700M and 700S are mounted on the lower panels 100M and 100S of the main and the subsidiary panel unit 300M and 300S, respectively.

The main FPCs 680M are folded and are attached to the top of the backlight unit 900, the auxiliary FPC 680S is connected between the driving FPC 650 and the lower panel 100S of the subsidiary panel unit 300S, and the main FPC 680M is connected to the driving FPC 650 in a folded state. The driving FPC 650 is disposed at the top of the backlight unit 900, and the subsidiary panel unit 300S is disposed in the opening 690 thereof.

Referring back to FIG. 1, the driving voltage generator 720 generates a gate-on voltage Von, a gate-off voltage Voff, and first to third reference voltages AVDD, GVDD, and VcomH.

The gray voltage generator 800 includes a resistor string comprised of a plurality of resistors (not shown) and one end of the resistor string is connected to the second reference voltage GVDD and the other end thereof is connected to a ground voltage, and it generates one set or two sets of gray voltages related to a transmittance of the pixels. When two sets of the gray voltages are generated, the gray voltages in one set have a positive polarity with respect to the common voltage Vcom, while the gray voltages in the other set have a negative polarity with respect to the common voltage Vcom.

The gate driver 400 synthesizes the gate-on voltage Von and the gate-off voltage Voff to generate gate signals for application to the gate lines G₁-Gₙ. The gate driver is a shift register, which includes a plurality of stages in a line.

The data driver 500 is connected to the data lines D₁-Dₘ of the panel unit 300 and amplifies data voltages selected from the gray voltages supplied from the gray voltage generator 800 via a plurality of amplifiers (not shown) for application to the data lines D₁-Dₘ. The first reference voltage AVDD is used to determine operation ranges of the amplifiers.

The common voltage generator 710 generates a common voltage having a high level and a low level repeated periodically for application to the panel unit 300.

The signal controller 600 controls the gate driver 400 and the data driver 500.

The driving chip (700M or 700S) includes the signal controller 600, the gate driver 400, the data driver 500, and the driving voltage generator 720 for each panel unit as shown in FIG. 1 as a single integrated chip. The driving chip may further include the gray voltage generator 800 and the common voltage generator 710.

FIG. 5 shows an exemplary block diagram of the main and the subsidiary driving chips 700M and 700S. The main and the subsidiary driving chips 700M and 700S include signal controllers 600M and 600S, data drivers 500M and 500S, and gate drivers 400ML, 400MR, 400SL, and 400SR disposed at the left and right of each driving chip 700M and 700S, respectively. The main driving chip 700M further includes driving voltage generators 720L and 720R disposed at the left and right thereof. The subsidiary driving chip 700S may receive voltages required for its own driving, for example, the gate voltages Von and Voff, and the first to the third voltages AVDD, GVDD, and VcomH via the power supply line 330.

Each of the main and subsidiary driving chips 700M and 700S is supplied with external signals via the connector 660 (FIG. 3B), and processed signals for control of the main panel unit 300M and the subsidiary panel unit 300S are supplied thereto via signal lines provided on the driving FPC 650 and the main and the auxiliary FPCs 680M and 680S.

Now, the operation of the display device will be described in detail referring to FIG. 1.

The signal controller 600 is supplied with image signals R, G, and B and input control signals controlling the display of the image signals R, G, and B from an external graphic controller (not shown). The input control signals include, for example, a vertical synchronization signal Vsync, a horizontal synchronization signal Hsync, a main clock MCLK, and a data enable signal DE. After generating gate control signals CONT1 and data control signals CONT2 and processing the image signals R, G, and B to be suitable for the operation of the panel unit 300 in response to the input control signals, the signal controller 600 provides the gate control signals CONT1 to the gate driver 400, and the processed image signals DAT and the data control signals CONT2 to the data driver 500.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages (with respect to the common voltage Vcom).

The data driver 500 receives the processed image signals DAT for a pixel row from the signal controller 600 and converts the processed image signals DAT into the analogue data voltages selected from the gray voltages supplied from the gray voltage generator 800 in response to the data control signals CONT2 from the signal controller 600.

In response to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dm for a turn-on time of the switching elements Q (which is called “one horizontal period” or “1H” and equals one period of the horizontal synchronization signal Hsync, the data enable signal DE, and the gate clock signal CPV). The data voltages in turn are supplied to corresponding pixels via the turned-on switching elements Q.

The difference between the data voltage and the common voltage Vcom applied to a pixel is expressed as a charged voltage of the LC capacitor C_{LC}, i.e., a pixel voltage. The liquid crystal molecules have orientations depending on a magnitude of the pixel voltage and the orientations determine a polarization of light passing through the LC capacitor C_{LC}. The polarizers convert light polarization into light transmittance.

By repeating the above-described procedure, all gate lines G₁-Gₙ are sequentially supplied with the gate-on voltage Von during a frame, thereby applying the data voltages to all pixels. In the case of the LCD shown in FIG. 1, when a next frame starts after finishing one frame, the inversion control signal RVS applied to the data driver 500 is controlled such that a polarity of the data voltages is reversed (“frame inversion”). The inversion control signal RVS may be controlled such that the polarity of the data voltages flowing in a data line in one frame is reversed (e.g. “row inversion”, “dot inversion”), or the polarity of the data voltages in one packet is reversed (e.g. “column inversion”, “dot inversion”).

A dual display device, and in particular, an LCD dual display device according to embodiments of the present invention, will now be described in detail with reference to FIGS. 5-10.

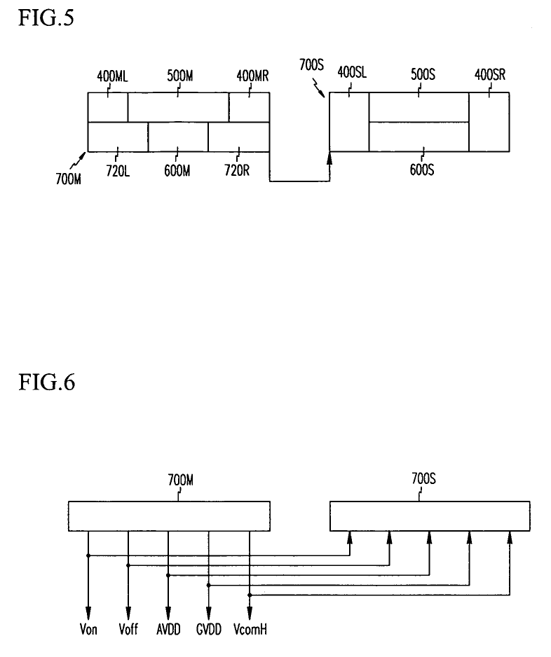

FIGS. 6-10 show a plurality of exemplary schemes of sharing voltages in a dual display device according to an embodiment of the present invention.

First, the driving voltage generator 720 of the main driving chip 700M generates the gate-on voltage Von, the gate-off voltage Voff, and the first to the third reference voltages AVDD, GVDD, and VcomH, which are transmitted to the subsidiary driving chip 700S via the power supply line 330.

For the example shown in FIG. 6, the main and the subsidiary driving chips 700M and 700S share all of the gate voltages Von and Voff, and the first to the third reference voltages AVDD, GVDD, and VcomH in common. Herein, when the characteristics of the main and the subsidiary panel units 300M and 300S are the same, for example, the kind of LCs being used in the main and subsidiary panel units thereof are the same, the two panel units are driven at the same time. But when the characteristics of the main and the subsidiary panel units 300M and 300S are not the same, one of the two panel units 300M and 300S is preferably driven.

For example, the main panel unit 300M uses panels which are not reflective and an LC layer 3 interposed therebetween which is easily activated for a low pixel voltage, and the subsidiary panel unit 300S uses panels which are reflective and an LC layer 3 interposed therebetween which is activated for a normal pixel. The low voltage-activated LC layer 3 operates in a range of the pixel voltage of 3.2V and the normal LC layer 3 operates in a range of the pixel voltage of 3.8V. In this case, only one of the two panel units 300M and 300S is driven, and, if the subsidiary panel unit 300S is driven, the second and the third reference voltages GVDD and VcomH inputted to the subsidiary driving chip 700S are adjusted to be suitable for the operation of the subsidiary panel unit 300S.

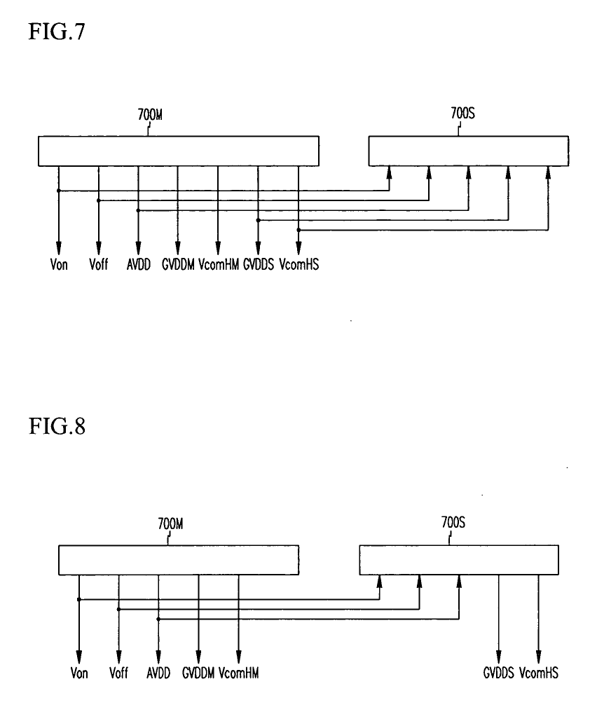

Meanwhile, for the embodiments shown in FIGS. 7-10, the gate voltages Von and Voff and the first reference voltage AVDD are generated from the main driving chip 700M to be supplied to the subsidiary driving chip 700S similar to the embodiment shown in FIG. 6, but schemes for supplying the second and the third reference voltage GVDD and VcomH thereto are different from the embodiment shown in FIG. 6.

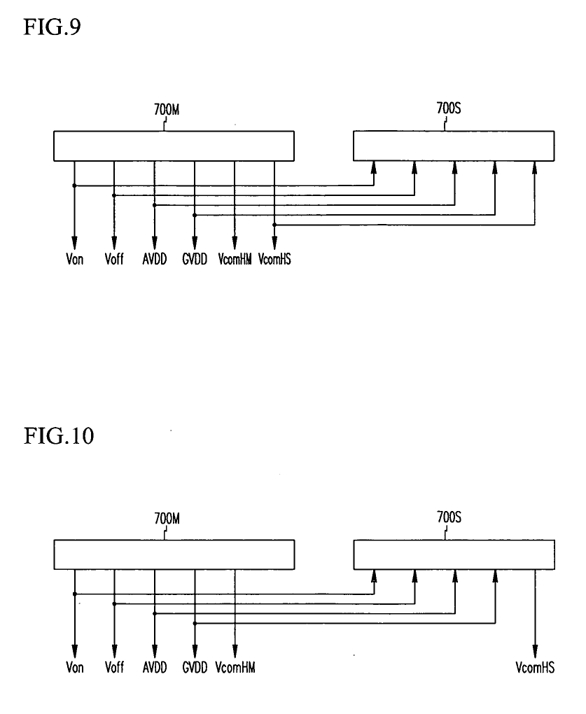

For example, for the embodiment shown in FIG. 7, the main driving chip 700M generates second and third reference voltages GVDDS and VcomHS for supplying to the subsidiary driving chip 700S, and for the embodiment shown in FIG. 8, the subsidiary driving chip 700S itself generates second and third reference voltages GVDDS and VcomHS. For the embodiment shown in FIG. 9, the main driving chip 700M generates a third reference voltage VcomHS for supplying to the subsidiary driving chip 700S, and for the embodiment shown in FIG. 10, the subsidiary driving chip 700S itself generates only a third reference voltage VcomHS.

For the embodiments shown in FIGS. 7-10, simultaneous driving or separate driving is possible irregardless of whether the characteristics of the two panel units 300M and 300S are the same or not, as opposed to the embodiment shown in FIG. 6 where both panel units have to be driven together. When the embodiments in FIGS. 7-10 are used, for a dual liquid crystal display, different kinds of LCs can be used for the main and the subsidiary panels. Thus, when the second reference voltage GVDD is adjusted for the main panel unit 300M as shown in FIGS. 9 and 10, it is preferably adjusted to be suitable for the operation of the LC layer 3 of the subsidiary panel unit 300S.

As described above, the main and the subsidiary driving chips 700M and 700S share three to five voltages in common, and thus the number of elements required for the power supply is decreased, thereby reducing the size of the dual display device and the manufacturing cost.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A display device comprising:
a first panel unit;
a first driving chip driving the first panel unit;
a second panel unit; and
a second driving chip driving the second panel unit,
wherein the first and second driving chips share at least a portion of a plurality of power supply voltages required for driving the first panel unit and the second panel unit.

2. The display device of claim 1, wherein the plurality of power supply voltages comprise first to third voltages, and the first to third voltages are generated from the first driving chip and are supplied to the second driving chip.

3. The display device of claim 2, wherein the plurality of power supply voltages further comprise fourth and fifth voltages, and
the fourth and fifth voltages are generated from the first driving chip and are supplied to the second driving chip.

4. The display device of claim 2, wherein the plurality of power supply voltages further comprises fourth to seventh voltages, and
the fourth to seventh voltages are generated from the first driving chip, and the sixth and seventh voltages are supplied to the second driving chip.

5. The display device of claim 2, wherein the plurality of power supply voltages further comprises fourth to seventh voltages, and
the fourth and fifth voltages are generated from the first driving chip, and the sixth and seventh voltages are generated from the second driving chip.

6. The display device of claim 2, wherein the plurality of power supply voltages further comprises fourth to sixth voltages, and
the fourth to sixth voltages are generated from the first driving chip, and the fourth and sixth voltages are supplied to the second driving chip.

7. The display device of claim 2, wherein the plurality of power supply voltages further comprises fourth to sixth voltages, and
the fourth and fifth voltages are generated from the first driving chip, the sixth voltage is generated from the second driving chip, and the fourth voltages are supplied to the second driving chip.

8. The display device of one of claims 3 to 7, further comprising:
first and second flexible printed circuit films (FPCs) each attached to one side of the respective first and second panel units; and
a third FPC having a first side and a second side, wherein the first and second FPCs are attached to the respective first and second sides of the third FPC.

9. The display device of claim 8, wherein the third FPC is provided with a power supply line transmitting the plurality of power supply voltages.

10. The display device of claim 8, wherein the first and second panel units are provided with a plurality of pixels each including a switching element, and first and second display signal lines connected to the switching elements.

11. The display device of claim 10, further comprising:
a gate driver generating gate signals for application to the first display signal lines; and
a data driver generating data voltages for application to the second display signal lines.

12. The display device of claim 11, wherein the first and second driving chips each comprise the gate driver and the data driver for the respective first and second panel units.

13. The display device of claim 12, further comprising:
a gray voltage generator generating gray voltages for application to the data driver; and
a common voltage generator generating a common voltage.

14. The display device of claim 13, wherein the first and second driving chip each further comprises the gray voltage generator and the common voltage generator.

15. The display device of claim 1, wherein the first and second driving chip are mounted on the first and second panel units, respectively.

16. The display device of claim 1, wherein the plurality of power supply voltages comprise first to fifth voltages, and the first and second driving chips share at least the first to third voltages in common.

17. The display device of claim 16, further comprising:
a gate driver receiving the first and second voltages to generate gate signals;
a data driver receiving the third voltage to generate data voltages;
a gray voltage generator receiving the fourth voltage to generate gray voltages; and
a common voltage generator receiving the fifth voltage to generate a common voltage.

18. The display device of claim 17, further comprising:
first and second FPCs each attached to one side of the respective first and second panel units; and
a third FPC having a first side and a second side, wherein the first and second FPCs are attached to the respective first and second sides of the third FPC.

19. The display device of claim 18, wherein the third FPC is provided with a power supply line transmitting the plurality of power supply voltages.

20. The display device of claim 19, wherein the first and second driving chips are mounted as a COG (chip on glass) structure on the first and second panel units, respectively.

21. The display device of claim 20, wherein the first and second driving chips each comprises at least one of the gate driver, the data driver, the gray voltage generator, and the common voltage generator.
